(19) United States
(12) Patent Application Publication
(10) Pub. No.: US 2012/0012475 A1
(43) Pub. Date: Jan. 19, 2012

(54) DENTAL DEVICE CLEANSING APPARATUS AND METHOD

(76) Inventor: Jackie Mitchell, San Gabriel, CA (US)

(21) Appl. No.: 12/837,761

(22) Filed: Jul. 16, 2010

(51) Int. Cl. B65D 81/00; B08B 1/00

(52) U.S. Cl. 206/207; 15/104.93

(57) ABSTRACT

A dental device cleansing apparatus comprising a cleansing wipe and a cleansing liquid. The cleansing liquid includes a flavor, and a small amount of alcohol in an aqueous solution. The dental device cleansing apparatus cleans by applying the cleansing liquid to the cleansing wipe to moisten and enable the cleansing wipe to remove particles and saliva from a dental device.

### BACKGROUND OF THE INVENTION

1. Field of the Invention

The present invention relates to a cleansing apparatus for dental devices to clean away particles and odor left on the devices after use.

2. Description of Related Art

In the dental field, there are many appliances and devices created by dentists to be worn by their patients. The various appliances may be retainers meant to maintain the placement of a person's teeth after wearing braces, mouth guards worn by a person to prevent harm or damage to the teeth and mouth while the wearer plays a sport, whitening trays worn by a person to whiten their teeth, or a night guard to prevent a person from grinding their teeth in their sleep. All of these devices help the person care for and even improve their teeth.

While there are various appliances which may be worn in a user's mouth, there are not many ways to clean the dental devices. Some people simply rinse the device under water and store the device until the next use. Rinsing alone may cause bacteria and odor to form on the device, resulting in a dirtier device than when it was in the wearer's mouth. Many people brush off their appliances with a toothbrush to remove debris then place the appliance in a storage box. Others use an effervescent cleanser to clean the device, by placing the device in water, adding the effervescent tablet and then letting it soak in the solution. This method does clean the device but it is time consuming and messy. The procedure must be done in a bathroom in case the containers filled with the cleaning solution spill or splash.

Another problem is how some individuals wear their dental devices in public and then remove them in front of other people; this is especially problematic while eating. Other people may be offended by seeing the dirty dental device on the table or on a napkin while they are trying to eat a meal. The device may emit a foul odor from the saliva and particles, which would be displeasing to any person including the wearer.

It would be desirable in the art to provide a dental device cleaning apparatus that enables a person to clean their dental devices without having to stay in the bathroom and use a toothbrush or require the cups of cleansing solution. It would also be desirable to have a cleansing apparatus which may be used discretely and may hide the dental device while not in use.

### SUMMARY OF THE INVENTION

The primary purpose of the present invention is to provide a dental device cleansing apparatus to clean and refresh the dental appliances worn by many individuals. The dental device cleansing apparatus includes a cleaning wipe and a cleansing liquid to remove any particles or odors from the device. The cleansing wipes may be offered from a dispenser or as individually wrapped as pre-moistened towelettes. Either way, the cleansing wipes are treated with the cleansing liquid which is an aqueous solution comprising a flavor, to be pleasing to the user, and a small amount of alcohol to sufficiently clean and dry the dental device.

Another object of the primary invention is to provide a way to discretely clean and then hide the dental device while in public.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a perspective view of a cleansing wipe and a spray bottle in accordance with an exemplary embodiment of the present invention;

FIG. 2 is a perspective view a cleansing wipe within a packet in accordance with an alternative embodiment of the present invention;

FIG. 3 is a perspective view of a cleansing wipe with a dispenser in accordance with an exemplary embodiment of the present invention; and

FIG. 4 is a perspective view of a cleansing wipe in accordance with a second alternative embodiment of the present invention.

Like reference numerals refer to like parts throughout the description of several views of the drawings.

### DETAILED DESCRIPTION OF THE DRAWINGS

The present invention relates to a dental device cleansing apparatus to clean and refresh the dental appliances worn by a wearer. The dental device cleansing apparatus may comprise a cleansing wipe and a cleansing liquid. The cleansing wipe may come in a variety of different shapes and transport method, which will be described below. The cleansing liquid may come in a separate spray bottle to be added to the cleansing wipe, or already be incorporated into the cleansing wipe before distribution. The various shapes of the cleansing wipes, and dispensing methods of the dental device cleansing apparatus will be described and explained below while referring to the figures.

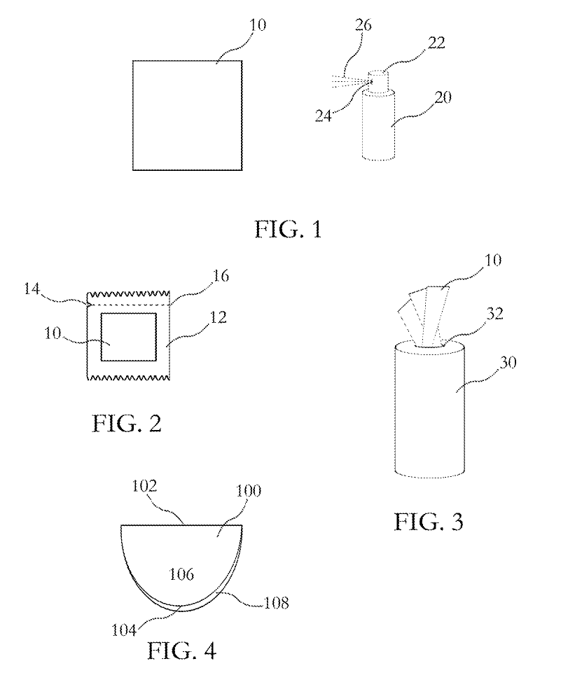

Turning now descriptively to the drawings, referring to FIG. 1, a perspective view of a cleansing wipe (10) is shown in accordance with an exemplary embodiment of the present invention. The cleansing wipe (10) may have a square, circular, rectangular shape or any other geometric or decorative shape desired by a user. The cleansing wipe (10) may be approximately 6 inches by 6 inches square but may vary depending on the particular shape used. The cleansing wipe (10) may be made from a paper material or a thin woven fabric able to resist tearing when moistened, similar to a towelette or baby wipe. A spray bottle (20) may dispense a liquid cleanser used to moisten the cleansing wipe (10). The bottle (20) includes an actuator (22) and a nozzle (24). When pressed by a user, the actuator (22) pumps a cleansing liquid (26) from the bottle (20), out the nozzle (24) and onto the cleaning wipe (10). The cleansing liquid (26) must be fit for human consumption, because the cleansing liquid will come in contact with a dental device which in turn will be placed inside the user's mouth. The cleansing liquid (26) may have a flavor pleasing to the user, yet contain a slight alcohol content in an aqueous solution. The aqueous solution may enable the cleansing liquid to clean the dental device and to dry quickly while tasting good and providing fresh breath for the user. The flavor in the aqueous solution may be mint, citrus or fruit depending on the preference of the user. The dental device may be a retainer, mouth guard, whitening tray, night guard or any other dental appliance normally removable by a wearer.

Referring to FIG. 2, a perspective view of the cleansing wipe (10) is shown inside of a sealed packet (12) in accordance with an alternative embodiment of the present invention. The sealed packet (12) may hold the cleansing wipe (10) after the cleansing wipe has been folded and pre-moistened with the cleansing liquid. In one particular embodiment, the sealed packet (12) includes a notch (14) to tear open the packet (12) along a perforated line (16) to remove the cleansing wipe (10). While the cleansing wipe (10) is in the sealed packet (12), the user may easily transport the individually wrapped wipes for convenient cleaning of their dental device and then quick disposal of all contents (i.e., the packet and the wipe) into the trash. The cleansing wipe (10) stays moist inside the sealed packet (12) without having to carry the bottle when using the cleansing wipe outside the home. The sealed packet (12) may have a plastic lining or a thin metal lining to prevent air from getting into the packet (12), and to ensure the cleansing wipe stays moist and does not dry out.

Referring to FIG. 3, a perspective view of the cleansing wipe (10) is shown coming from a dispenser (30) in accordance with an exemplary embodiment of the present invention. The dispenser (30) may house a plurality of cleansing wipes (10) each folded against the next in an alternating fashion or connected together as a long strip of material divided at a perforated edge. The plurality of cleansing wipes (10) may lay folded and stacked inside the dispenser (30) until one-by-one they are pulled from a hole (32) on the top of the dispenser (30). When a cleansing wipe (10) is pulled from the dispenser (30) it may pull the next cleansing cloth (10) through the hole (32). The next cleansing cloth (10) may release from the first cleansing cloth if in the alternating fashion, or it may tear at the perforated edge if all the wipes are connected. The dispenser (30) may be made of plastic and waterproof like a baby wipe dispenser, to house a plurality of pre-moistened cleansing wipes, or the dispenser (30) may be made from a cardboard or paper material to house a plurality of dry cleansing wipes. If the cleansing wipes (10) are dry the spray bottle (20) may be used to moisten the cleansing wipe (10) for use. If the cleansing wipes (10) are pre-moistened the spray bottle (20) is unnecessary, and the dispenser may have a snap top to close the hole (32) and prevent the cleansing wipes (10) from drying. The dispenser (30) may be decorated to be aesthetically pleasing to the user.

Referring to FIG. 4, a perspective view of a cleansing wipe (100) is shown in accordance with a second alternative embodiment of the present invention. The cleansing wipe (100) may have an oval or circular shape, and when the cleansing cloth (100) is folded in half a straight edge (102) and a curved edge (104) may be seen. The cleansing cloth (100) may have a front flap (106) and a back flap (108). The half-circle or half-moon shape of the cleansing cloth (100) may allow the user to slide their dental device between the front flap (106) and the back flap (108) after wiping so that the device will not be seen while eating or not in use.

In a third alternative embodiment of the present invention, the cleansing wipe (100) may also be shaped like a pocket wherein an opening is along the straight edge (102) and the front flap (106) and the back flap (108) are joined along the curved edge (104). Thus, the dental device may slide into the opening along the straight edge (102), and rest between the front flap (106) and the back flap (108) while being secured inside the cleansing wipe (100) by the closed curved edge (104). Both the second and third alternative embodiments may be produced in individually wrapped, pre-moistened packets or in a dispenser. If with the cleansing wipes (100) are dry, the spray bottle is necessary to wet the cleansing wipe (100) and clean the dental device. The pocket structured cleansing wipe coupled with the sealed packet may provide a disposable carrying case for the user, by enabling the user to easily slip the dental device into the cleansing wipe then into the packet. The user may then place the packet in their purse or pocket to discretely hide the dental device while eating or until needed again. After use and removal of the dental device, the packet and cleansing wipe may be thrown into the trash.

The cleansing wipes along with the cleansing liquid may provide a user with a convenient way to clean and freshen up the dental device after removal from their mouth. The cleansing wipes may ensure that the dental devices remain free of debris and free of bad odors which may accumulate after wearing the device for an extended period of time. The user may have a better peace of mind knowing that their dental appliance does not have any foreign particles stuck in the crevices, and knowing their mouth does not emit a malodorous smell coming from the dental device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A dental device cleansing apparatus comprising:
a cleansing wipe; and
a cleansing liquid wherein the cleansing liquid comprises;
a flavor, and
a small amount of alcohol in an aqueous solution,
wherein the cleansing liquid is applied to the cleansing wipe to moisten and enable the cleansing wipe to remove particles and saliva from a dental device.

2. The dental device cleansing apparatus of claim 1, wherein the flavor is mint, citrus or fruit.

3. The dental device cleansing apparatus of claim 1, wherein the cleansing wipe is made from a paper material.

4. The dental device cleansing apparatus of claim 1, wherein the cleansing wipe is square shaped.

5. The dental device cleansing apparatus of claim 4, wherein a plurality of cleansing wipes fit into a dispenser for storage.

6. The dental device cleansing apparatus of claim 1, wherein the cleansing wipe is circular.

7. The dental device cleansing apparatus of claim 6, wherein the circular cleansing wipe folds in half to create a half-moon cleansing wipe with a curved edge and a straight edge to wrap around the dental device.

8. The dental device cleansing apparatus of claim 1, wherein the cleansing wipe is shaped as a pocket comprising a straight edge, a curved edge, a front flap and a back flap, where the curved edge joins the front flap and the back flap together and the straight edge is open to allow insertion of the dental device.

9. The dental device cleansing apparatus of claim 1, wherein the cleansing wipe is folded, pre-moistened with the cleansing liquid and housed is a sealed packet.

10. The dental device cleansing apparatus of claim 9, wherein the sealed packet includes a notch and a perforated line to tear open the sealed packet and remove the cleansing wipe.
